(19) United States
(12) Patent Application Publication
(10) Pub. No.: US 2006/0048544 A1
(43) Pub. Date: Mar. 9, 2006

(54) Molding core

(75) Inventor: Kun-Chih Wang, Taichung (TW)

Correspondence Address: DLA PIPER RUDNICK GRAY CARY US, LLP, 2000 UNIVERSITY AVENUE, E. PALO ALTO, CA, 94303-2248, US

(73) Assignee: ASIA OPTICAL CO., INC.

(21) Appl. No.: 11/151,877

(22) Filed: Jun. 13, 2005

(30) Foreign Application Priority Data
Sep. 3, 2004 (TW) 093126674

(51) Int. Cl. C03B 11/08

(52) U.S. Cl. 65/374.15; 65/374.11

(57) ABSTRACT

A molding core includes: a core body having an article-shaping surface; and a hard coating formed on the article-shaping surface of the core body and including a diamond-like carbon film that includes carbon, oxygen, and at least one bonding-enhancing element which is selected from silicon, titanium, aluminum, tungsten, tantalum, chromium, zirconium, vanadium, niobium, hafnium, and boron, and which forms covalence bonding with the carbon and the oxygen.

### CROSS-REFERENCE TO RELATED APPLICATION

This application claims priority of Taiwanese Application No. 093126674, filed on Sep. 3, 2004.

### BACKGROUND OF THE INVENTION

1. Field of the Invention

This invention relates to a molding core, more particularly to a molding core with a hard coating that has a diamond-like carbon film with crystalline nano-particles formed therein for enhancing the chemical stability of the diamond-like carbon film.

2. Description of the Related Art

FIG. 1 illustrates a conventional molding core for a press-molding mold that is used for press molding of a glass preform 13 into an optical lens article. The conventional molding core includes a core body 11 and a protective film 12 formed on an article-shaping surface of the core body 11. Conventionally, the protective film 12 is made from a diamond-like carbon (DLC) structure. However, DLC tends to deteriorate due to oxidation or precipitation of undesired materials at the surface thereof under high working temperature, which results in roughening of the surface thereof, which, in turn, results in poor quality of the molded products. Moreover, the bonding strength between the DLC structure and the core body 11 decreases gradually after a period of use, which can result in peeling of the protective film 12 from the core body 11.

JP 9-227150 discloses a method for making a molding core that includes the steps of forming a DLC film on a core body, implanting nitrogen ions into the DLC film using ion implantation techniques, and subsequently subjecting the DLC film to a heating treatment under a nitrogen atmosphere so as to form covalence bonding between carbon and nitrogen in the DLC film and so as to enhance chemical stability of the DLC film. However, the improvement in the chemical stability of the aforesaid DLC film by the covalence bonding between carbon and nitrogen is limited, and there is still a need to further enhance the chemical stability of the DLC film and to lengthen the service life of the DLC film.

### SUMMARY OF THE INVENTION

The object of the present invention is to provide a molding core that is capable of overcoming the aforesaid drawbacks of the prior art.

According to this invention, there is provided a molding core for a press-molding mold. The molding core comprises: a core body having an article-shaping surface; and a hard coating formed on the article-shaping surface of the core body and including a diamond-like carbon film that comprises carbon, oxygen, and at least one bonding-enhancing element which is selected from the group consisting of silicon, titanium, aluminum, tungsten, tantalum, chromium, zirconium, vanadium, niobium, hafnium, and boron, and which forms covalence bonding with the carbon and the oxygen.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic view of a conventional molding core; and

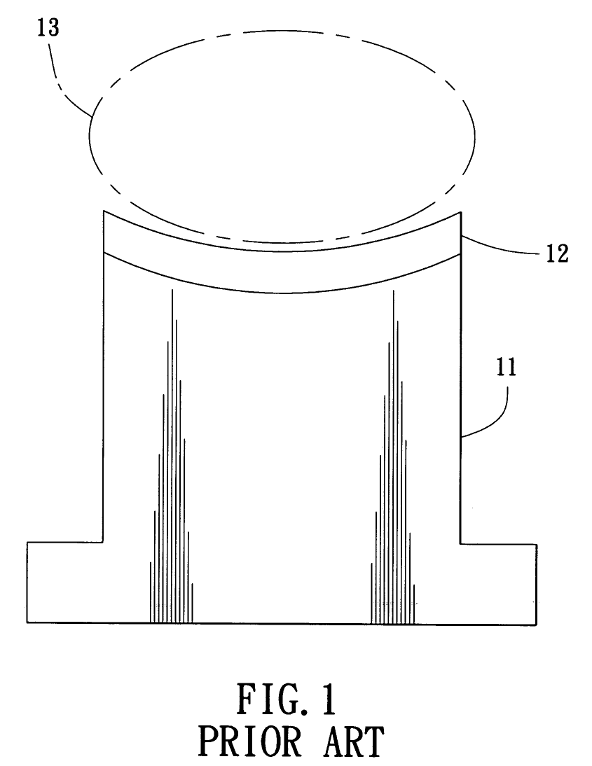

FIG. 2 is a schematic view of the preferred embodiment of a molding core according to this invention.

### DETAILED DESCRIPTION OF THE PREFERRED EMBODIMENT

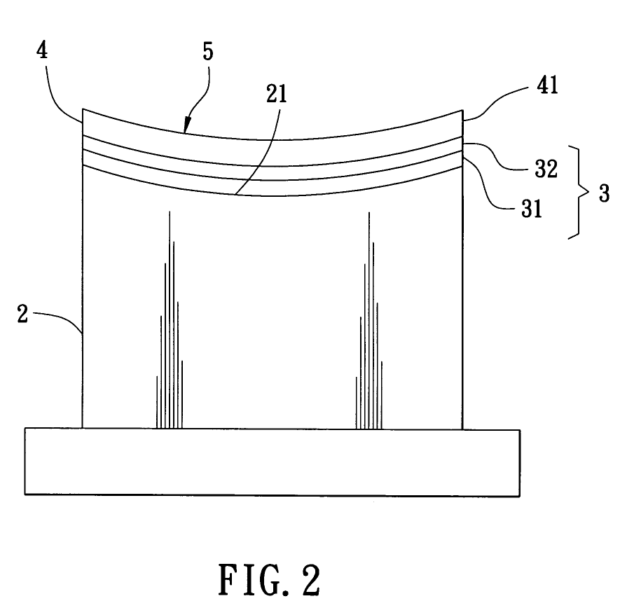

FIG. 2 illustrates the preferred embodiment of a molding core used in a press-molding mold (not shown) for making optical lens articles according to the present invention.

The molding core includes: a core body 2 having an article-shaping surface 21; and a hard coating 5 formed on the article-shaping surface 21 of the core body 2 and including a diamond-like carbon film 4 that comprises carbon, oxygen, and at least one bonding-enhancing element which is selected from the group consisting of silicon, titanium, aluminum, tungsten, tantalum, chromium, zirconium, vanadium, niobium, hafnium, and boron, and which forms covalence bonding with the carbon and the oxygen. Preferably, the bonding-enhancing element is silicon.

Preferably, the diamond-like carbon film 4 has a thickness ranging from 100 to 150 nm, and is formed with crystalline nano-particles of a carbide of the bonding-enhancing element and crystalline nano-particles of an oxide of the bonding-enhancing element, which are dispersed uniformly therein.

The core body 2 is preferably made from a material selected from the group consisting of tungsten carbide, silicon carbide, and silicon nitride, and is more preferably made from tungsten carbide.

In this embodiment, the hard coating 5 further includes an intermediate film 3 sandwiched between the core body 2 and the diamond-like carbon film 4, and including a composite layer 31 of a silicon carbide and an amorphous carbon layer 32. The composite layer 31 is formed on the article-shaping surface 21 of the core body 2, and has a thickness ranging from 50 to 100 nm. The amorphous carbon layer 32 is sandwiched between the composite layer 31 and the diamond-like carbon film 4, comprises carbon, oxygen, and silicon which forms covalence bonding with the carbon and the oxygen, and preferably has a thickness ranging from 50 to 100 nm. Preferably, the amorphous carbon layer 32 comprises crystalline nano-particles of a silicon carbide and crystalline nano-particles of a silicon oxide dispersed uniformly therein.

The molding core is made by a method comprising the steps of: preparing the core body 2 with the article-shaping surface 21 having a shape conforming to that of the optical lens article (not shown); forming the composite layer 31 on the article-shaping surface 21 of the core body 2 using sputtering deposition techniques; forming the amorphous carbon layer 32 on the composite layer 31 using ion plating techniques; and forming the diamond-like carbon film 4 on the amorphous carbon layer 32 using ion plating techniques.

Formation of the diamond-like carbon film 4 is conducted by supplying a carbon-containing source, a oxygen-containing source, a hydrogen-containing source, and a bonding-enhancing element-containing source to a reaction chamber (not shown) during the ion plating.

The bonding-enhancing element-containing source is a silicon-containing material selected from the group consisting of solid silicon, silanes, silazanes, and combinations thereof.

The silanes is selected from the group consisting of SiH₄, tetramethylsilane ((CH₃)₄Si), trimethylsilane ((CH₃)₃SiH), dimethylsilane ((CH₃)₃SiH₂), tetraethylsilane ((C₂H₅)₄Si), triethylsilane ((C₂H₅)₃SiH), diethylsilane ((C₂H₅)₂SiH₂), and combinations thereof.

The silazanes is preferably hexamethyldisilazane (HMDS).

The carbon-containing source is preferably a hydrocarbon group having from 1 to 7 carbon atoms, and is prefearbly selected from the group consisting of benzene, hexamethyldisilazane (HMDS), methane, acetylene, toluene, and combinations thereof. HMDS can be used as a source for each of the carbon-containing source, the bonding-enhancing element-containing source, and the oxygen-containing source. When HMDS and benzene are used for the formation of the diamond-like carbon film 4, the atomic percentage of carbon, oxygen, and silicon in the diamond-like film 4 can be adjusted through control of the mass flow rate ratio of HMDS to benzene in a reaction chamber during ion plating. The ratio preferably ranges from 4:1 to 1:4. The higher the flow rate of HMDS, the higher will be the chemical stability of the diamond-like carbon film 4, and the lower will be the hardness of the diamond-like carbon film 4.

In addition to HMDS, the bonding-enhancing element-containing source can also be diborane (B₂H₆) or aluminum tert-butylate (C₄H₉)₃Al.

Preferably, the ion plating for the formation of the diamond-like carbon film 4 is conducted at a reaction temperature ranging from 250 to 400° C. The diamond-like carbon film 4 formed after the ion plating is subsequently subjected to annealing at an annealing temperature ranging from 600 to 700° C. so as to form the crystalline nano-particles of the oxide of the bonding-enhancing element and the crystalline nano-particles of the carbide of the bonding-enhancing element in the diamond-like carbon film 4.

### EXAMPLE

This invention will now be described in greater detail with reference to the following Example.

### Example 1

The core body 2 employed in this Example was made from tungsten carbide. The composite layer 31 was formed by sputtering techniques by using a chamber (not shown) that was evacuated to a base pressure of 5×10⁻⁴ Pa and that was controlled at a deposition temperature of 350° C. Ar gas was introduced into the chamber, and the pressure was controlled to 3×10⁻¹ Pa. High frequency (RF) power of 500W was applied to the chamber to bombard a silicon target for forming a thickness of 50 nm of the composite layer 31 on the core body 2. The amorphous carbon layer 32 was formed by ion plating techniques by introducing HMDS gas into the chamber and controlling the pressure to 2×10⁻¹ Pa. A self-biased voltage of 2.5 kV was produced in the core body 2 (substrate). The plating was conducted at a working temperature of 250° C. for 30 minutes so as to form a thickness of 50 nm of the amorphous carbon layer 32 on the composite layer 31.

The diamond-like carbon film 4 was formed by ion plating by introducing HMDS and benzene gases into the chamber in a mass flow rate ratio of 1:2 (HMDS:benzene). The ion plating was conducted at a pressure of 5×10⁻¹ Pa and a working temperature of 250° C. for 60 minutes so as to form a thickness of 100 nm of the diamond-like carbon film 4 on the amorphous carbon layer 32.

The diamond-like carbon film 4 thus formed can be subjected to heat treatment (annealing) so as to increase formation of the crystalline nano-particles of the silicone carbide and the crystalline nano-particles of the silicon oxide and so as to enhance chemical stability of the diamond-like carbon film 4.

The molding core prepared by Example 1 and a conventional molding core which was formed with a conventional DLC film were subjected to chemical stability testing. The results show that the molding core of this invention can be used in press molding over 3000 times, while the molding surface of the conventional molding core became rough and damaged as peeling of the DLC film was observed after being in use for 500 times.

By virtue of the presence of the bonding-enhancing element in the diamond-like carbon film 4, the aforesaid drawbacks associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A molding core useful for molding a glass, comprising:
a core body having an article-shaping surface; and
a hard coating formed on said article-shaping surface of said core body and including a diamond-like carbon film that comprises carbon, oxygen, and at least one bonding-enhancing element which is selected from the group consisting of silicon, titanium, aluminum, tungsten, tantalum, chromium, zirconium, vanadium, niobium, hafnium, and boron, and which forms covalence bonding with the carbon and the oxygen.

2. The molding core of claim 1, wherein said diamond-like carbon film comprises crystalline nano-particles of a carbide of said bonding-enhancing element and crystalline nano-particles of an oxide of said bonding-enhancing element dispersed therein.

3. The molding core of claim 1, wherein said bonding-enhancing element is silicon.

4. The molding core of claim 3, wherein said hard coating further includes an intermediate film sandwiched between said core body and said diamond-like carbon film.

5. The molding core of claim 4, wherein said intermediate film includes a composite layer of a silicon carbide formed on said article-shaping surface of said core body.

6. The molding core of claim 5, wherein said composite layer has a thickness ranging from 50 to 100 nm.

7. The molding core of claim 6, wherein said intermediate film further includes an amorphous carbon layer that is sandwiched between said composite layer and said diamond-like carbon film and that comprises carbon, oxygen, and silicon which forms covalence bonding with the carbon and the oxygen.

8. The molding core of claim 7, wherein said amorphous carbon layer comprises crystalline nano-particles of a silicon carbide and crystalline nano-particles of a silicon oxide dispersed therein.

9. The molding core of claim 8, wherein said amorphous carbon layer has a thickness ranging from 50 to 100 nm.

10. The molding core of claim 1, wherein said diamond-like carbon film has a thickness ranging from 100 to 150 nm.

11. The molding core of claim 1, wherein said core body is made from a material selected from the group consisting of tungsten carbide, silicon carbide, and silicon oxide.
